(19) United States
(12) Patent Application Publication
(10) Pub. No.: US 2014/0278270 A1
(43) Pub. Date: Sep. 18, 2014

(54) DESIGN OPTIMIZER SYSTEM

(71) Applicant: C&D ZODIAC, INC., Huntington Beach, CA (US)

(72) Inventors: Scott Savian, Huntington Beach, CA (US); Sandesh Shetty, Huntington Beach, CA (US); Adam Sbeglia, Huntington Beach, CA (US)

(73) Assignee: C&D ZODIAC, INC., Huntington Beach, CA (US)

(21) Appl. No.: 13/841,840

(22) Filed: Mar. 15, 2013

(51) Int. Cl. G06F 17/50

(52) U.S. Cl. CPC G06F 17/5095
USPC 703/1

(57) ABSTRACT

A computerized system for optimizing the design layout of an aircraft configured to execute, by at least one processor, the instructions of one or more software modules stored on a nonvolatile computer readable medium, the system comprising a first software module configured to receive input from a user regarding number of seats; a second software module configured to receive input from a user regarding seat pitch; a third software module configured to receive input from a user regarding meal service; a fourth software module configured to receive input from a user regarding beverage service; a fifth software module configured to comprise a listing of all possible combinations of all aircraft interior layout configurations for an aircraft. The sixth software module uses the inputs from one or more of the first, second, third, or fourth software modules to determine and create an output of the one configuration that takes up the least amount of seat space, weighs the least, and contains the most amount of aircraft cabin storage space. A seventh software module graphically displays the output of the sixth software module.

### FIELD OF THE INVENTION

The present invention relates generally to semi-automatic design optimization. In particular, the invention provides a system and method to semi-automate the process of optimizing an aircraft interior solution (LOPA) to best support the customer/airline mission.

### BACKGROUND OF THE INVENTION

In certain applications, product design is highly individualized and depends on the particular needs of a specific customer. These are referred to as “custom” designs and are designed for a particular set of specifications making each manufactured product unique. In custom designs, since an array of product variations are offered to the customer, typically no two aircraft interiors are exactly the same. In custom designs, a design may be used for a single product or a relatively small quantity of manufactures. As such, the time and effort spent on each design directly adds to the cost and time necessary for the life cycle of a single product. In mass production, this design time and cost may be amortized among the thousands of manufactures and becomes a small part of the expense of each product. In custom design, by contrast, the design time and cost cannot be amortized in this way due to the relatively small number of products that may be manufactured from each design.

In commercial aviation, the interior space of an aircraft is an extremely valuable commodity. This is particularly true for aircraft that may be used for commercial passenger transfer, as the number of passengers on a given flight, together with the amount of revenue that may be generated from ticket sales for that flight (which itself is dependent on the market rate a passenger may be willing to pay for a given level of flight service), may determine whether operation of the flight will be profitable. Many other variables also exist that affect flight operation profitability, including the weight of the various seats and seat configurations that may be used, the number and type of aircraft galleys, lavatories, and other monuments (including the particular size and layout of such monuments), and the overall, general layout of the interior structures of an aircraft. Indeed, before an aircraft can be used for commercial passenger transport, its interior must be outfitted, configured, and optimized to account for these and other variables, so as to ensure that a carrier or aircraft owner's target goals for use of the aircraft can be achieved.

In the past, in order to outfit, configure, and optimize the interior of an aircraft to account for these many variables, a design engineer typically would have to manually attempt to plan the aircraft interior layout. This often would have to be done, in essence, through trial and error, where the design engineer manually creates an aircraft interior layout plan (a time intensive process of itself), and then assess the pros and cons of the particular layout and the manner in which the layout impacts the aforementioned variables, including the various weight parameters, the amount of revenue that could be generated per passenger for the particular layout, and whether the particular layout presents the greatest balance or optimization of the variables in order to achieve maximum profitability (or other target goals, as the case may be). Moreover, the ultimate layout of the aircraft interior often depends upon the specific skill level of the customer or individual designing the layout. As such, significant design variability and inefficiencies are inherent in such a process. In addition, an aircraft interior is comprised of thousands of parts, the configuration and implementation of which is necessarily a task that requires significant customization, and often results in the overall task taking months or years to complete. This is the case because aircraft interior layouts must be manually configured (an iterative process), and each iteration can take days to months or longer in some cases. The present invention eliminates or reduces these problems inherent in the prior art design methods.

On top of these challenges, design engineers also must account for specific and often rigorous governmental regulatory requirements concerning interior aircraft design, which challenge is further compounded because regulatory requirements often vary from one country to the next. And, once a specific layout plan has been manually created by the design engineer after a lengthy expenditure of time, to the extent the particular plan is not optimal, the engineer may have to spend considerable time modifying the plan (again, through a trial and error process or some use of existing designs) in order to optimize the interior layout plan to achieve the best balance of the many variables so as to achieve the targeted design goal. And as discussed above, even when a given layout for a particular aircraft, customer, and target goal has been achieved, it is very unlikely that any one particular “custom” layout will exactly match another customer's target goals, where the customer has another aircraft needing an interior layout design. This often may be true, even where the aircraft type or model is identical. As such, the time intensive interior layout and design process must be repeated from the beginning.

In light of these and other challenges in the prior art, there exists a need for a system and method to automate or semi-automate the process of interior aircraft design, such that a design engineer can readily and quickly configure and optimize the interior layout plan for an aircraft, and then easily adjust various aspects and ascertain, in real time, the ramifications of such adjustments vis-à-vis the various variables discussed above.

### SUMMARY OF THE PREFERRED EMBODIMENTS

In accordance with an aspect of the present invention, there is provided a computerized system for optimizing the design layout of an aircraft configured to execute, by at least one processor, the instructions of one or more software modules stored on a nonvolatile computer readable medium, the system comprising a first software module configured to receive input from a user regarding number of seats; a second software module configured to receive input from a user regarding seat pitch; a third software module configured to receive input from a user regarding meal service; a fourth software module configured to receive input from a user regarding beverage service; a fifth software module configured to comprise a listing of all possible combinations of all aircraft interior layout configurations for an aircraft. The sixth software module uses the inputs from one or more of the first, second, third, or fourth software modules to determine and create an output of the one configuration that takes up the least amount of seat space, weighs the least, and contains the most amount of aircraft cabin storage space. A seventh software module graphically displays the output of the sixth software module.

In a preferred embodiment of the present invention, the system further comprises an eighth software module configured to receive input from a user regarding level of service, and the sixth software module may use input from the eighth software module to determine and create an output of the one configuration that takes up the least amount of seat space, weighs the least, and contains the most amount of aircraft cabin storage space. Preferably, the system further comprises a ninth software module configured to receive input from a user regarding flight duration, and wherein the sixth software module may use input from the ninth software module to determine and create an output of the one configuration that takes up the least amount of seat space, weighs the least, and contains the most amount of aircraft cabin storage space. Preferably, the fifth software module comprises separate lists for two or more different aircraft. Preferably, the system further comprises a tenth software module configured to receive input from a user regarding aircraft type, which input from the tenth software module regarding aircraft type causes the sixth software module to identify the one configuration that takes up the least amount of seat space, weighs the least, and contains the most amount of aircraft cabin storage space, from among the configurations that are listed in the separate list in the fifth software module corresponding to the aircraft type input from the tenth software module. Preferably, the graphical display of the seventh software module includes the position of one or more seats. Preferably, the graphical display of the seventh software module includes the position and type of one or more aircraft interior monuments. Preferably, the system further comprises an eleventh software module, which eleventh software module is configured to provide the weight of one or more aircraft interior layouts. Preferably, the system further comprises a twelfth software module, which twelfth software module is configured to provide the revenue generated from ticket sales for the aircraft interior layout configuration combination identified by the sixth software module. Preferably, the output of the sixth software module is printed on paper by a printer.

In accordance with another aspect of the present invention there is provided a method for optimizing the design layout of an aircraft by a user accessing software instructions stored on a nonvolatile computer readable medium, which software instructions are executed by at least one processor. The method comprises: receiving input from the user regarding number of seats; receiving input from the user regarding seat pitch; receiving input from the user regarding meal service; receiving input from the user regarding beverage service; listing all possible combinations of all aircraft interior layout configurations for an aircraft; determining and creating an output of the one configuration that takes up the least amount of seat space, weighs the least, and contains the most amount of aircraft cabin storage space; and graphically displaying the output of the one configuration that takes up the least amount of seat space, weighs the least, and contains the most amount of aircraft cabin storage space.

In a preferred embodiment, the method further comprises receiving input regarding level of service, and wherein the input regarding level of service may be used to determine and create an output of the one configuration that takes up the least amount of seat space, weighs the least, and contains the most amount of aircraft cabin storage space. Preferably, the method further comprises receiving input regarding flight duration, and wherein the input regarding flight duration may be used to determine and create an output of the one configuration that takes up the least amount of seat space, weighs the least, and contains the most amount of aircraft cabin storage space. Preferably, separate aircraft layout configuration lists for two or more different aircraft are created. Preferably, the method further comprises receiving input regarding aircraft type, which input regarding aircraft type is used to identify the one configuration that takes up the least amount of seat space, weighs the least, and contains the most amount of aircraft cabin storage space, from among the separate list of aircraft layout configurations corresponding to the input regarding aircraft type. Preferably, the graphical display includes the position of one or more seats. Preferably, the graphical display includes the position and type of one or more aircraft interior monuments. Preferably, the weight of one or more aircraft interior layouts is determined and presented. Preferably, the revenue generated from ticket sales for the aircraft interior layout configuration that takes up the least amount of seat space, weighs the least, and contains the most amount of aircraft cabin storage space, is determined and presented. Preferably, the output of the one configuration that takes up the least amount of seat space, weighs the least, and contains the most amount of aircraft cabin storage space, is printed on paper by a printer.

### BRIEF DESCRIPTION OF THE DRAWINGS

FIG. 1 is a block diagram of a computerized design optimizer in accordance with an embodiment of the present invention;

FIG. 2 is a block diagram of an overview flow chart of a computerized design optimizer in accordance with an embodiment of the present invention;

FIG. 3 is a block diagram of an overview flow chart of a computerized design optimizer in accordance with an embodiment of the present invention;

FIG. 4 is a block diagram of a detailed flow chart of a computerized design optimizer in accordance with an embodiment of the present invention;

FIG. 5 is an exemplar screen shot showing the features, input controls, and output controls/results of a computerized optimizer in accordance with an embodiment of the present invention;

FIG. 6 is an exemplar screen shot showing the features, input controls, and output controls/results of a computerized optimizer in accordance with an embodiment of the present invention;

FIG. 7 is an exemplar screen shot showing the features, input controls, and output controls/results of a computerized optimizer in accordance with an embodiment of the present invention;

FIG. 8 is an exemplar screen shot showing information output of a computerized optimizer in accordance with an embodiment of the present invention;

FIG. 9 is an exemplar screen shot showing the features, input controls, and output controls/results of a computerized optimizer in accordance with an embodiment of the present invention;

FIG. 10 is an exemplar screen shot showing information output of a computerized optimizer in accordance with an embodiment of the present invention;

FIG. 11 is an exemplar screen shot showing the features, input controls, and output controls/results of a computerized optimizer in accordance with an embodiment of the present invention;

FIG. 12 is an exemplar screen shot showing information output of a computerized optimizer in accordance with an embodiment of the present invention;

FIG. 13 is an exemplar screen shot showing the features, input controls, and output controls/results of a computerized optimizer in accordance with an embodiment of the present invention; and

FIG. 14 is an exemplar screen shot showing information output of a computerized optimizer in accordance with an embodiment of the present invention.

### DETAILED DESCRIPTION OF THE PREFERRED EMBODIMENTS

The following description of embodiments of the present invention refers to the accompanying figures. Where appropriate, the same reference numbers in different figures refer to the same or similar elements. The following description and figures are illustrative and are not to be construed as limiting. Numerous specific details are described to provide a thorough understanding of the disclosure. However, in certain instances, well known or conventional details are not described in order to avoid obscuring the description of inventive aspects of the present invention. References to one or an embodiments in the present disclosure can be, but not necessarily are references to the same embodiment; and, such references mean at least one of the embodiments. Unless otherwise stated, like numerals within the figures refer to the same or similar features or aspects of the present invention, as among all figures.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments but not necessarily by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure may be discussed below, or elsewhere in the specification, to provide additional guidance to the practitioner regarding the description of the disclosure. For convenience, certain terms may be highlighted, for example using italics and/or quotation marks; however, the use of highlighting has no influence on the scope and meaning of a term. The scope and meaning of a term is the same, in the same context, whether or not it is highlighted. It will be appreciated that the same thing can be said in more than one way.

Consequently, alternative language and synonyms may be used for any one or more of the terms discussed herein. Nor is any special significance to be placed upon whether or not a term is elaborated or discussed herein. Synonyms for certain terms may be provided. A recital of one or more synonyms does not exclude the use of other synonyms. The use of examples anywhere in this specification, including examples of any terms discussed herein, is illustrative only and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art in the field of the present invention. In the case of conflict, the present document, including definitions, will control.

Referring now to the drawings, which are for purposes of illustrating the present invention and not for purposes of limiting the same, FIG. 1, is a block diagram showing a computerized design optimizer system 100 in accordance with the present invention. Preferably, system 100 comprises a computer device capable of receiving user initiated input commands, processing data, and outputting the results for the user. System 100 consists of RAM (memory) 110, hard disk 120, network 130, central processing unit (CPU) 140, mouse 150, keyboard 160, video display 170, a printer 180, and a server 190. It will be understood and appreciated by those of skill in the art that the computer device of system 100 could be replaced with, or augmented by, any number of other computer device types or processing units, including but not limited to a desktop computer, laptop computer, mobile or tablet device, or the like. Similarly, hard disk 120 could be replaced with any number of computer storage devices, including flash drives, removable media storage devices (CDs, DVDs, etc.), or the like.

Network 130 can consist of any network type, including but not limited to a local area network (LAN), wide area network (WAN), and/or the internet. Server 190 can consist of any computing device or combination thereof, including but not limited to the computing devices described herein, such as a desktop computer, laptop computer, mobile or tablet device, as well as storage devices that may be connected to network 130, such as hard drives, flash drives, removable media storage devices, or the like.

The storage devices (e.g., hard disk 120, server 190, or other devices known to persons of ordinary skill in the art), are intended to be nonvolatile, computer readable storage media to provide storage of computer-executable instructions, data structures, program modules, and other data for the computing device of system 100, which are executed by CPU/processor 140 (or the corresponding processor of such other components). The various components of the present invention, modules or steps 125, are stored or recorded on hard disk 120 or other like storage devices described above, which may be accessed and utilized by the computing device of system 100, the server 190 (over network 130), or any of the peripheral devices described herein, including video display 170 and/or printer 180. One or more of the modules or steps 125 of the present invention also may be stored or recorded on server 190, and transmitted over network 130, to be accessed and utilized by the computer device of system 100, or any other computing device that may be connected to one or more of the computing devices of system 100, the network 130, and/or the server 190.

Software and web or internet implementations of the present invention could be accomplished with standard programming techniques with rule based logic and other logic to accomplish the various steps of the present invention described herein. It should also be noted that the terms “component,” “module,” or “step,” as may be used herein and in the claims, are intended to encompass implementations using one or more lines of software code, macro instructions, hardware implementations, and/or equipment for receiving manual inputs, as will be well understood and appreciated by those of ordinary skill in the art. Such software code, modules, or elements may be implemented with any programming or scripting language such as C, C++, C#, Java, Cobol, assembler, PERL, Python, PHP, or the like, or macros using Excel or other similar or related applications with various algorithms being implemented with any combination of data structures, objects, processes, routines or other programming elements.

Referring now to FIG. 2, a block diagram of a high level overview flow chart of a computerized design optimizer in accordance with the present invention is shown. In particular, FIG. 2 is intended to represent a high level strategy for the system of the present invention. The first step is to define the mission, i.e., the goals or aspirations of the customer/airline and what it wants to achieve in a particular aircraft interior configuration layout (step 40). Next, mission requirements to attain the customer/airline goals are compiled and assimilated (step 50). Next, a layout of passenger accommodations (LOPA) is generated based upon the customer/airline goals (step 60). Depending upon whether the resulting LOPA meets or does not meet the customer airline goals (i.e., good or bad), the mission and/or mission requirements may be modified (steps 80 and 90), and ultimately, a desirable outcome or solution is achieved (step 70).

Referring now to FIG. 3, a block diagram of an overview flow chart of a computerized design optimizer in accordance with the present invention is shown. At first module or step 210 of the present invention, manual user inputs are provided. These include the level of comfort or level of service (which may be defined on a sliding scale from, for example, 1 through 10), the duration of the flight (which may be defined on a sliding scale from, for example, 1 through 6), the number of passengers on a given flight, the number of seats required, etc. Level of comfort or level of service refers to the overall level of passenger experience and comprises aspects such as quality of seats (e.g., leather vs. cloth), quality of meals (gourmet entrée items vs. cold meals vs. light snack service), general or specific seat pitch, etc. Once the inputs of module or step 210 have been made, module or step 230 determines the number of meals, beverages, trolleys, lavatories, galleys, ovens, and coffee makers required, and the space requirements for one or more of these items. Module or step 240, which contains a list of all possible layout configurations for a given aircraft, is then filtered down to determine the configuration that best fits the input values, and the number and space requirements of the various identified monuments and accessories. Module or step 250 provides an output of the optimal layout.

Referring now to FIG. 4, a block diagram of a detailed flow chart of a computerized design optimizer in accordance with the present invention is shown. At module or step 205, the specific aircraft type is selected from among a list of possible aircraft types. The selection of specific aircraft type at module or step 205 dictates the list of all possible layout configurations (240A), as the universe of combinations is aircraft specific (in light of variances among interior dimensions and other variables as between different aircraft types). Layout list 240A is comprised of a master list of all possible layout configurations for a given aircraft. Further, layout list 240A groups and configures the list of all possible lavatories, galleys, trolleys, and other monuments and accessories, such that all possible combinations and layouts of all such items are listed, as will be understood and appreciated by those of skill in the art. Layout list 240A also includes a corresponding list of the specifications of the items and other monuments and accessories (i.e., specific physical attributes and features, including but not limited to weight, dimensions, volume, and other such physical attributes and features as would be recognized by those of skill in the art).

At module or step 210A, the level of comfort/service (which may be on a sliding scale, for example, of 1 through 10) is selected. A higher number may denote a higher level of comfort/service, and a lower number may denote a lower level of comfort/service. As discussed, level of comfort or level of service refers to the overall level of passenger experience and comprises aspects such as quality of seats (e.g., leather vs. cloth), quality of meals (gourmet entrée items vs. cold meals vs. light snack service), general or specific seat pitch, etc. At module or step 210B, the duration of the flight (which may be on a sliding scale, for example, of 1 through 6) is selected. A higher number may denote a longer flight duration, and a lower number may denote a shorter flight duration.

From the inputs at modules or steps 210A and 210B, module or step 220 determines the level of service that will be required and makes a determination of the specific meal and beverage service type for a given flight, as well as a recommended seat pitch 210C. The level of service and the seat pitch also may be manually adjusted by user inputs. Module or step 225 provides recommendations (based upon market data) of specific needs for catering. Such market research may be performed in advance, and the results of the market research stored at module or step 225. In such a preferred embodiment, module or step 225 applies the inputs to the stored market research data.

At module or steps 210C and 210D, the number of business class passengers and economy plus class passengers are selected. At module or step 212A, all inputs, including comfort level 210A, duration 210B, number of business class passengers 210C, number of economy plus class passengers 210D, and seat pitch 210E are used to determine how much space is occupied by the business and economy plus class passenger seats, and the number of economy seats that can fit into the remainder of the aircraft is determined and presented at module or step 212B. Module 215 determines and presents the total number of passengers for the aircraft.

Based on the prior input, module or step 230A determines and presents the number of lavatories needed; module or step 230B determines the minimum number of trolleys and standard units required for meals and beverages. Module or step 230C determines the minimum number of ovens and coffee makers required for meals and beverages.

Based on the minimum values determined at module or steps 230B and 230C, module 240B determines those configurations (from the list of all possible layout configurations of module or step 240A), in which each value of the physical attribute specifications of the items on the list is greater than or equal to the minimum numbers determined at module or steps 230B and 230C. Module or step 240C then finds the one configuration (from those identified by module or step 240B) that takes up the least amount of seat space, weighs the least, and contains the most amount of miscellaneous storage space. In other words, modules or steps 240B and 240C, in effect, filter down the full list of all possible layout configurations (found at module or step 240A) and determine which single layout configuration best fits with the input values. The number and type of lavatories required is determined and presented at module or step 245A. The number and type of galleys required is determined and presented at module or step 245B. The number and type of windscreens required is determined at module or step 245C. The number and type of stowage units required is determined and presented at module or step 245D. The lavatory and seating options are determined and presented at module or step 260. Because the weight of the seating and the various components comprising the single configuration are known, the individual and total weight may be determined and presented at module or step 270. In addition, because the specific number of passengers, as well as the number of specific passengers for each fare class is known, an estimated flight revenue is determined and presented at module or step 270. It is contemplated and intended to be within the scope of the present invention that any determination and presentation described herein may be determined by way of CPU 140 or server 190, using data stored on hard disk 120, and may be transmitted across network 130. Moreover, it is contemplated and intended to be within the scope of the present invention that any determination and presentation, including any outputs described herein, may be presented to a user on display 170 and/or in hard copy or paper format by way of printer 180.

While the present diagrams of FIGS. 3 and 4 contemplate implementation of aircraft interior layout specifications using regulatory requirements of the Federal Aviation Administration in the United States, it is contemplated and intended that the present invention include and cover the selection and use of interior layout specifications using the regulatory requirements of other entities, including regulatory bodies of other countries (as depicted and shown, for example, by drop-down menu 304 of FIG. 6). It is also contemplated and intended to be within the scope of the present invention to include country specific or regional specific options, the selection of which tailors aircraft layout options and resulting configurations to match (or be consistent with), parameters or requirements of such country or region.

Referring to FIGS. 5 through 14, exemplar screen shots of an embodiment in accordance with the present invention are shown. The user interface in the embodiment shown in FIGS. 5 through 14 comprises graphical “buttons,” check-boxes, drop-down menus, and the like, which may be manipulated on screen by the user, such as by way of mouse 150 and display 170. Other means for achieving alternate forms of a user interface are known in the art and intended to be within the scope of the present disclosure.

Referring now to FIG. 5, the interface includes buttons 300 and 302, which allow a user to select a different aircraft type. Here, Bombardier CS100 and CS300 aircraft types are shown as options (and the CS300 aircraft type is shown as being selected). However, any other model or aircraft type may be included and is contemplated to be within the scope of the present invention. Drop-down menu 304 includes regulatory settings of various regulatory agencies, which can be selected (as shown in FIG. 6) and can be modified. The level of comfort/service (210A) may be input and modified by buttons 306. The flight duration (210B) may be input and modified by buttons 308. The number of business class passengers (210C) may be input and modified by buttons 310. The number of economy plus class passengers (210D) may be input and modified by buttons 312. The number of economy seats (212B) is presented at location 314, and the total passengers (215) are presented at location 316. Seat pitch (210E) for each respective class type is presented at buttons 318, 319, and 320. Seat pitch (210E) also may be input and modified by buttons 318, 319, and 320, for each respective class type.

Meal service (a portion of module or step 220) is shown at 324. Meal service (220), as shown at 324, is both an output of module 220, as well as an input, thus allowing a user to customize the selection. Beverage type (a portion of module or step 220) is shown at 326. Beverage type (220), as shown at 326, also is both an output of module 220, as well as an input, thus allowing a user to customize this selection as well.

Specific seat configurations are presented by way of a layout of passenger accommodations (“LOPA”) 328. Depending on the specific determinations made (as described herein), various monument types and placements are automatically provided and shown. For example, a type “1” galley is shown at 330 in the forward portion of the aircraft, and a type “4” galley is shown at 332 in the aft portion of the aircraft. The number “2” in the type 1 galley shown at 330 is intended to refer to a particular type 1 galley, and likewise, the number “3” in the type 4 galley shown at 332 is intended to refer to a particular type 4 galley. A type “A” lavatory is shown at 334 in the forward portion of the aircraft, and a type “D” lavatory is shown at 336 in the aft portion of the aircraft. Storage bins are shown at 338 in the aft portion of the aircraft.

“Update Layout” button 340 updates the LOPA 328, and other output variables, to the extent manual modifications are made to the inputs. The disclosure of the present invention also includes “real time” updating of LOPA 328 from user inputs, without having to press the update layout button 340. “Reset” button 342 is used to return the LOPA 328 and all input controls to their original state. “Show Details” button 344 presents the user with other output information (such as module or step 270). Such output information is depicted in FIGS. 8, 10, 12, and 14, for example. The “Return” check-box 348 allows the user to set up a configuration scenario where a given aircraft might need to be configured for an out-and-back trip, where restocking of the galley and other supplies might not be possible. In that scenario, when the “Return” check-box 348 is selected, adjustments are made to the aircraft configuration, such as by including larger galleys or increasing the number of galleys, for more storage space for example, in order to accommodate the fact that restocking after the first leg of the trip may not be possible. “Hard Divider” button 346 allows a user to specify whether the class divider in the aircraft is a hard or soft divider, and depending on the selection, modifications are made to the layout to accommodate the difference in size and weight as between these types of dividers.

It is contemplated that the graphical interface of the present invention also may include one or more check boxes or other graphical selection mechanisms, whereby different oxygen delivery methods can be selected. Depending on the specific type of oxygen delivery method that is used (e.g., chemical method as opposed to gaseous method), a cylinder may need to be placed above each seat row, and the diameter of the cylinder determines the space required for the PSU. This in turn will affect the number of seat rows, given that every seat will need a PSU. By selecting a particular oxygen delivery method, it is contemplated that software system of the present invention will automatically account for the selected oxygen delivery method, determine the proper placement of the PSU, and adjust or readjust the aircraft layout, including the seating configuration and layout, accordingly. Likewise, it is also contemplated that the graphical interface of the present invention also may include a drop down menu or other graphical selection mechanisms, whereby different seat types and/or seat features may be selected. Types of seats and seat features affects the seat pitch, which in turn affects the number of seats that may be used in a given configuration. By selecting a particular seat type or feature, it is contemplated that the software system of the present invention will automatically account for the specific seat type selected, and adjust or readjust the aircraft layout, including the seating configuration and layout, accordingly.

The numerical entry shown at 350 is intended to represent a measurement (units of inches in the present embodiment), of the distance between the forward most (or aft most) seat, and the closest monument. (See further, exemplar measurements 350, at FIGS. 11 and 13.) The measurement 350 changes as a result of user input of the other configuration variables, and it allows the user to “fine tune” a particular layout so as to further maximize the use of interior aircraft space.

In implementation, referring now to FIGS. 7 through 14, various input scenarios (represented in FIGS. 7, 9, 11, and 13), and various output scenarios corresponding to each respective input scenario (represented in FIGS. 8, 10, 12, and 14) are shown. For example, FIG. 7 depicts an input scenario having a relatively low comfort level selected with a relatively short flight duration. The output for this input scenario is depicted in FIGS. 7 and 8. As can be seen in FIG. 8 (and also in each successive output scenario of FIGS. 10, 12, and 14), an inventory listing specific components needed for each specific layout is presented (from module or step 240B). In contrast to FIG. 7 (where a relatively low comfort level is selected), FIG. 9 shows an input scenario having a relatively high level of comfort/service, and the differences in output for this input scenario, as compared to the input scenario depicted by FIG. 7, can be observed by comparing FIGS. 9 and 10 to FIGS. 7 and 8. Other various input scenarios are shown in FIGS. 11 and 13, and the respective differences in output as among the various scenarios can be observed.

The particular arrangement shown in the figures and described herein is intended to be only exemplary. Various details of the invention may be changed without departing from the scope of the invention. Furthermore, the foregoing description of the preferred embodiment of the invention and best mode for practicing the invention are provided for the purpose of illustration only and not for the purpose of limitation, the invention being defined by the claims. For example, while the present invention is not limited to performing the input steps or providing input information in any particular order, it is contemplated and intended to be within the scope of the present invention to perform the input steps or providing input information in an order or sequence that might be advantageous. For example (and not by way of limitation), it is intended to be within the scope of the present invention that an aircraft type input may be provided as a first or initial step, as the aircraft type drives the later decisions (both by the system of the present invention and the user) regarding choices and options that need to be selected for other aspects of the aircraft layout. Similarly, it is intended to be within the scope of the present invention that other user inputs, such as level of comfort/service, and/or duration of flight might be an initial or first step (or even an early step, and not necessarily the first step), as again, these (and other such “top level” inputs) drive later decisions made by the system and/or the user. In addition, the level of comfort/service and flight duration can drive any number of layout option variables that are not dependent on specific seating choices.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of, and examples for the disclosure are described above for illustrative purposes, various equivalent modifications are possible within the scope of the disclosure, as those skilled in the relevant art will recognize. Further any specific numbers noted herein are only examples; alternative implementations may employ differing values or ranges.

Any patents and applications and other references that may be noted herein, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure. Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A computerized system for optimizing the design layout of an aircraft configured to execute, by at least one processor, the instructions of one or more software modules stored on a nonvolatile computer readable medium, the system comprising:
a first software module configured to receive input from a user regarding number of seats;
a second software module configured to receive input from a user regarding seat pitch;
a third software module configured to receive input from a user regarding meal service;
a fourth software module configured to receive input from a user regarding beverage service;
a fifth software module configured to comprise a listing of all possible combinations of all aircraft interior layout configurations for an aircraft;
wherein a sixth software module uses the inputs from one or more of the first, second, third, or fourth software modules to determine and create an output of the one configuration, from the listing of the fifth software module, that takes up the least amount of seat space, weighs the least, and contains the most amount of aircraft cabin storage space; and
wherein a seventh software module graphically displays the output of the sixth software module.

2. The computerized system of claim 1, wherein the system further comprises an eighth software module configured to receive input from a user regarding level of service, and wherein the sixth software module may use input from the eighth software module to determine and create an output of the one configuration that takes up the least amount of seat space, weighs the least, and contains the most amount of aircraft cabin storage space.

3. The computerized system of claim 2, wherein the system further comprises a ninth software module configured to receive input from a user regarding flight duration, and wherein the sixth software module may use input from the ninth software module to determine and create an output of the one configuration that takes up the least amount of seat space, weighs the least, and contains the most amount of aircraft cabin storage space.

4. The computerized system of claim 3, wherein the fifth software module comprises separate lists for two or more different aircraft.

5. The computerized system of claim 4, wherein the system further comprises a tenth software module configured to receive input from a user regarding aircraft type, which input from the tenth software module regarding aircraft type causes the sixth software module to identify the one configuration that takes up the least amount of seat space, weighs the least, and contains the most amount of aircraft cabin storage space, from among the configurations that are listed in the separate list in the fifth software module corresponding to the aircraft type input from the ninth software module.

6. The computerized system of claim 5, wherein the graphical display of the seventh software module includes the position of one or more seats.

7. The computerized system of claim 6, wherein the graphical display of the seventh software module includes the position and type of one or more aircraft interior monuments.

8. The computerized system of claim 7 further comprising an eleventh software module, which eleventh software module is configured to provide the weight of one or more aircraft interior layouts.

9. The computerized system of claim 8 further comprising a twelfth software module, which twelfth software module is configured to provide the revenue generated from ticket sales for the aircraft interior layout configuration combination identified by the sixth software module.

10. The computerized system of claim 9, wherein the output of the sixth software module is printed on paper by a printer.

11. A computer implemented method for optimizing the design layout of an aircraft by a user accessing software instructions stored on a nonvolatile computer readable medium, which software instructions are executed by at least one processor, the method comprising:
receiving input from the user regarding number of seats;
receiving input from the user regarding seat pitch;
receiving input from the user regarding meal service;
receiving input from the user regarding beverage service;
listing all possible combinations of all aircraft interior layout configurations for an aircraft;
determining and creating an output of the one configuration that takes up the least amount of seat space, weighs the least, and contains the most amount of aircraft cabin storage space; and
graphically displaying the output of the one configuration that takes up the least amount of seat space, weighs the least, and contains the most amount of aircraft cabin storage space.

12. The method of claim 11, wherein the method further comprises receiving input regarding level of service, and wherein the input regarding level of service may be used to determine and create an output of the one configuration that takes up the least amount of seat space, weighs the least, and contains the most amount of aircraft cabin storage space.

13. The method of claim 12, wherein the method further comprises receiving input regarding flight duration, and wherein the input regarding flight duration may be used to determine and create an output of the one configuration that takes up the least amount of seat space, weighs the least, and contains the most amount of aircraft cabin storage space.

14. The method of claim 13, wherein separate aircraft layout configuration lists for two or more different aircraft are created.

15. The method of claim 14, wherein the method further comprises receiving input regarding aircraft type, which input regarding aircraft type is used to identify the one configuration that takes up the least amount of seat space, weighs the least, and contains the most amount of aircraft cabin storage space, from among the separate list of aircraft layout configurations corresponding to the input regarding aircraft type.

16. The method of claim 15, wherein the graphical display includes the position of one or more seats.

17. The method of claim 16, wherein the graphical display includes the position and type of one or more aircraft interior monuments.

18. The method of claim 17, wherein the weight of one or more aircraft interior layouts is determined and presented.

19. The method of claim 18, wherein the revenue generated from ticket sales for the aircraft interior layout configuration that takes up the least amount of seat space, weighs the least, and contains the most amount of aircraft cabin storage space, is determined and presented.

20. The method of claim 19, wherein the output of the one configuration that takes up the least amount of seat space, weighs the least, and contains the most amount of aircraft cabin storage space, is printed on paper by a printer.
